(19) United States
(12) Patent Application Publication
(10) Pub. No.: US 2014/0156058 A1
(43) Pub. Date: Jun. 5, 2014

(54) IMAGE IDENTIFYING SYSTEM AND METHOD FOR IDENTIFICATION OF FINISHED PROCESS BY IMAGING

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/831,880

(22) Filed: Mar. 15, 2013

(30) Foreign Application Priority Data
Dec. 3, 2012 (TW) 101145361

(51) Int. Cl. G05B 19/406

(52) U.S. Cl. CPC G05B 19/406
USPC 700/178

(57) ABSTRACT

An image identifying method for a manufacturing process which is implemented by an image identifying system. The image identifying system is applied on a mold which ejects finished products. A retrieval mechanism takes out the ejected product. An image-capturing unit captures an image of the retrieval mechanism after the retrieval mechanism has taken out the finished product. The storage unit stores a predetermined image of a complete and successful retrieval of retrieval mechanism a finished product. If the acquired image is not the same with the predetermined image in the storage unit; all actions on the mold are suspended.

### BACKGROUND

1. Technical Field

The present disclosure relates to image identifying systems and, particularly, to an image identifying system and method for identification of finished process by imaging.

2. Description of Related Art

Conventionally, molds usually includes two parts: an ejecting mechanism and a retrieval mechanism. The ejecting mechanism ejects finished products. The retrieval mechanism takes out the ejected finished products. After the finished products have been successfully taken out, the ejecting mechanism will close the mold and be ready for the ejection of other finished products. However, if the finished products have not been completely or successfully taken out, the action of closing the mold will cause the mold to be damaged.

Therefore, what is needed is an image identifying system for finished process by imaging to overcome the above described limitations.

### BRIEF DESCRIPTION OF THE DRAWINGS

FIG. 1 is a block diagram of the hardware infrastructure of an image identifying system of FIG. 1, in accordance with an exemplary embodiment.

FIG. 2 shows a predetermined image indicating that finished product has been successfully taken out.

FIG. 3 shows an image of a retrieval mechanism after the retrieval mechanism has taken out the finished products.

FIG. 4 is a flowchart of an image identifying method implemented by the image identifying system of FIG. 1, in accordance with an exemplary embodiment.

### DETAILED DESCRIPTION

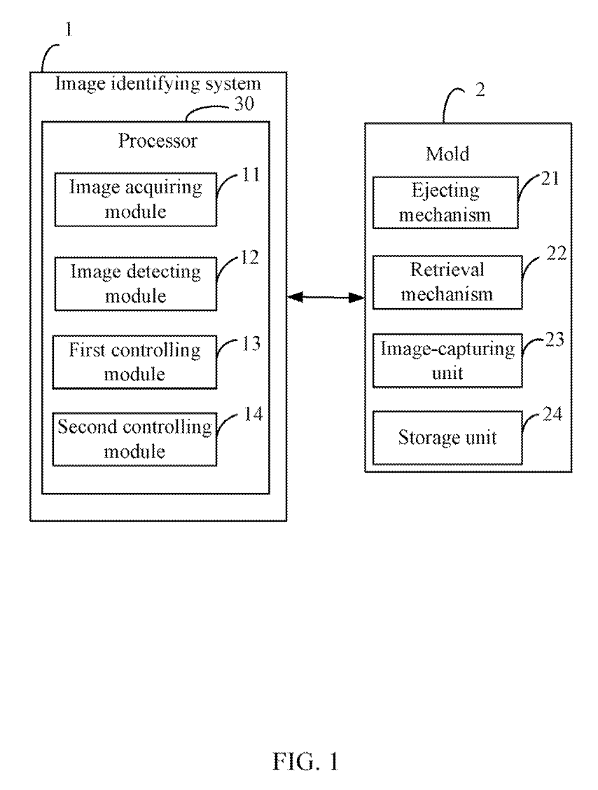

Referring to FIG. 1, an image identifying system 1 is provided. The image identifying system 1 is applied on a mold 2. The mold 2 includes an ejecting mechanism 21, a retrieval mechanism 22, an image-capturing unit 23, and a storage unit 24. The ejecting mechanism 21 ejects finished product. The retrieval mechanism 22 takes out the finished product ejected by the ejecting mechanism 21. The image-capturing unit 23 captures an image of the retrieval mechanism 22 after an action of the retrieval mechanism 22 has taken out the finished product. The storage unit 24 stores a predetermined image of the retrieval mechanism 22. The predetermined image shows the retrieval mechanism 22 successfully and completely taking out a finished product. The storage unit 24 can for example be or include any kind of suitable electronic storage such as a memory, a hard disk, or the like.

The image identifying system 1 includes at least one processor 30 and a number of modules to be executed by the at least one processor 30. The number of modules includes an image acquiring module 11, an image detecting module 12, a first controlling module 13, and a second controlling module 14.

The image acquiring module 11 acquires an image of the retrieval mechanism 22 from the image-capturing unit 23. The image detecting module 12 detects whether the acquired image is the same with the predetermined image 241. In one embodiment, the predetermined image 241 includes a comparing portion 242 and a remaining portion 243, the image detecting module 12 only acquires the comparing portion of the acquired image, and compares the comparing portion of the acquired image with the comparing portion 242 of the predetermined image 241 to determine whether the acquired image is the same with the predetermined image 241. The first controlling module 13 suspends all actions in relation to the mold 2 when the acquired image is not the same with the predetermined image in the storage unit 24. The second controlling module 14 controls the ejecting mechanism 21 to close the mold 2 and be set up to eject the next finished product.

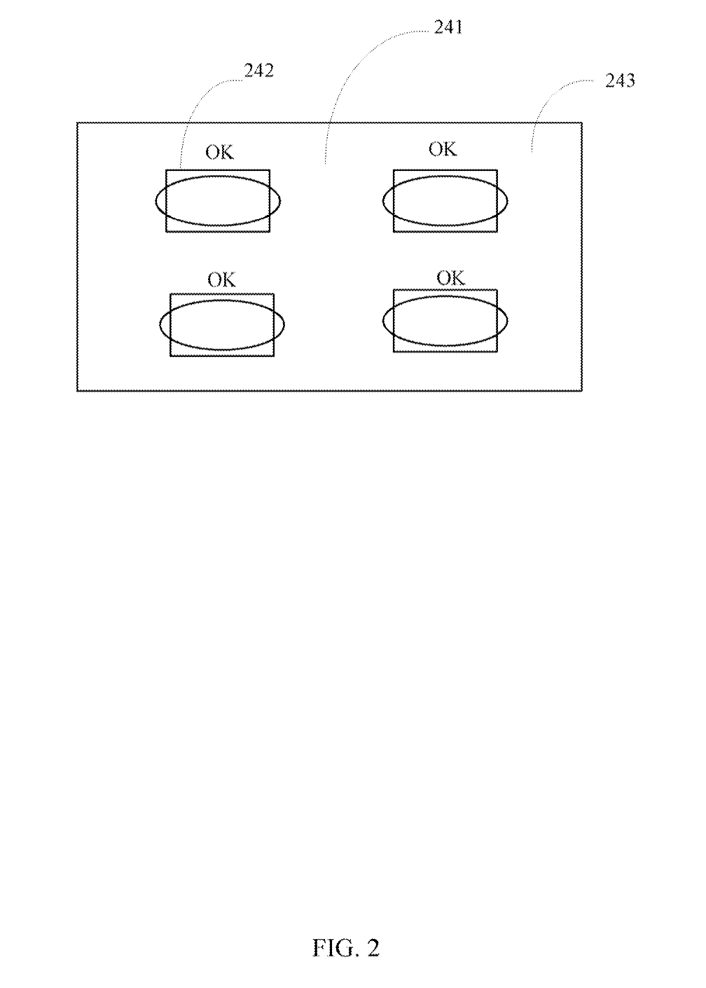

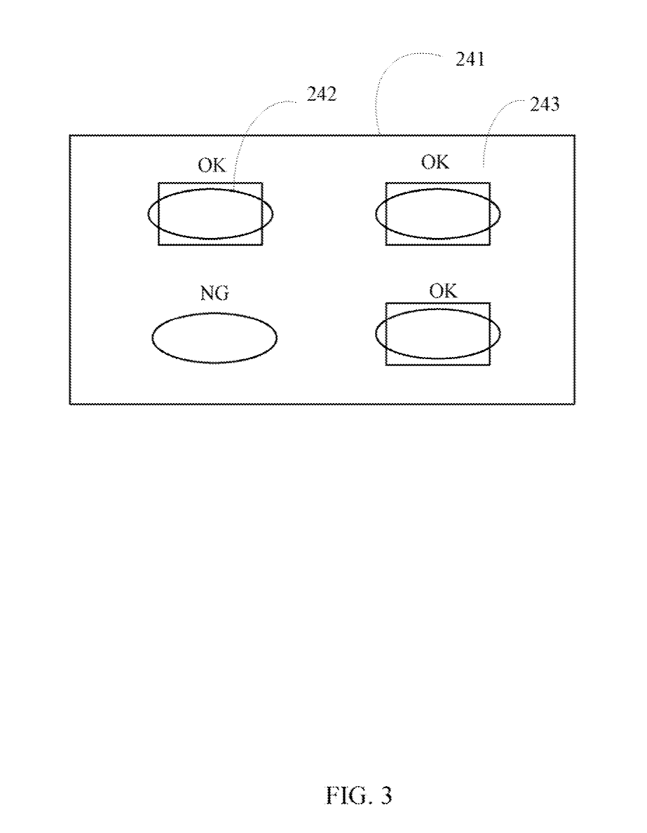

FIGS. 2-3 show an image of the retrieval mechanism 22 acquired by the image-capturing unit 23 which is not the same with the predetermined image shown in FIG. 2, which means that the finished product has not been successfully and completely taken out by the retrieval mechanism 22. The first controlling module 13 suspends all actions in relation to the mold 2, thereby preventing damage to the mold 2.

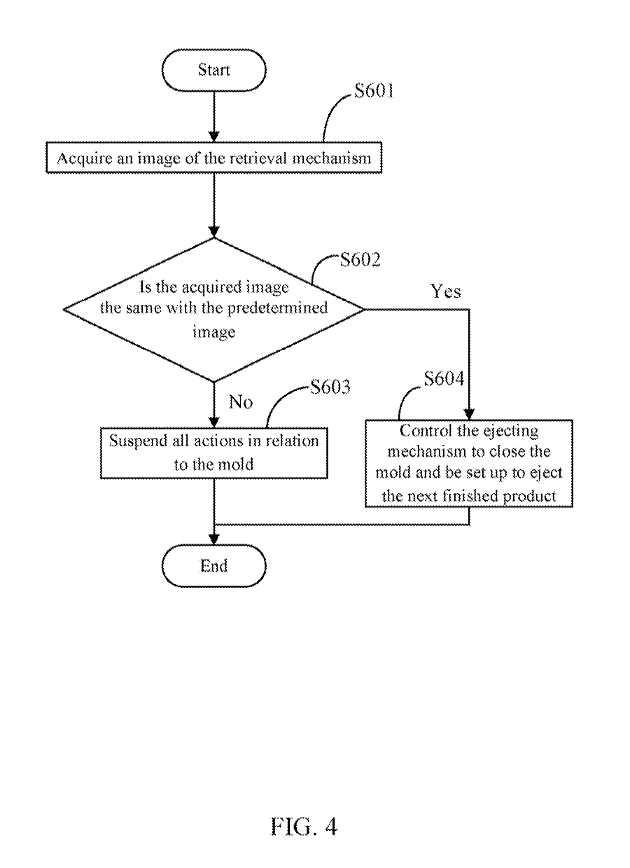

FIG. 4 is a flowchart of an image identifying method implemented by the image identifying system of FIG. 1, in accordance with an exemplary embodiment.

In step S601, the image acquiring module 11 acquires an image of the retrieval mechanism 22 from the image-capturing unit 23.

In step S602, the image detecting module 12 detects whether the acquired image is the same with a predetermined image, if yes, the procedure goes to step S604, if no, the procedure goes to step S603.

In step S603, the first controlling module 13 suspends all actions in relation to the mold 2.

In step S604, the second controlling module 14 controls the ejecting mechanism 21 to close the mold and ready itself to eject the next finished product.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An image identifying system for identification of finished process on a mold, wherein the mold comprises an ejecting mechanism, a retrieval mechanism, an image-capturing unit, and a storage unit, the ejecting mechanism ejects finished products, the retrieval mechanism takes out the ejected finished product, the image-capturing unit captures an image of the retrieval mechanism after the retrieval mechanism has taken out the finished product, the storage unit stores a predetermined image of the retrieval mechanism, the predetermined image shows the retrieval mechanism successfully taking out the finished product, the image identifying system comprising:
a least one processor; and
a plurality of modules to be executed by the at least one processor, wherein the plurality of modules comprises:
an image acquiring module configured to acquire an image of the retrieval mechanism from the image-capturing unit;
an image detecting module configured to detect whether the acquired image is the same with the predetermined image in the storage unit; and
a first controlling module configured to suspend all actions in relation to the mold when the acquired image is not the same with the predetermined image.

2. The image identifying system as described in claim 1, wherein the plurality of modules further comprises a second controlling module configured to control the ejecting mechanism to close the mold and be set up to eject the next finished product.

3. An image identifying method for identification of finished process being implemented by an image identifying system, wherein the image identifying system is applied on a mold, the mold comprises an ejecting mechanism, a retrieval mechanism, an image-capturing unit, and a storage unit, the ejecting mechanism ejects finished product, the retrieval mechanism takes out the ejected finished product, the image-capturing unit captures an image of the retrieval mechanism after the retrieval mechanism has taken out the finished product, the storage unit stores a predetermined image of the retrieval mechanism, the predetermined image shows the retrieval mechanism successfully taking out the finished product, the image identifying method comprising:
acquiring an image of the retrieval mechanism from the image-capturing unit;
detecting whether the acquired image is the same with the predetermined image in the storage unit; and
suspending all actions in relation to the mold when the acquired image is not the same with the predetermined image.

4. The image identifying method as described in claim 3, further comprising:
controlling the ejecting mechanism to close the mold and be set up to eject the next finished product when the acquired image is the same with the predetermined image.
